(19) United States
(12) Patent Application Publication
(10) Pub. No.: US 2026/0142812 A1
(43) Pub. Date: May 21, 2026

(54) CRYPTOGRAPHICALLY ANCHORED PUBLIC KEY DISTRIBUTION FRAMEWORK

(71) Applicant: Kishore Swaminathan, Willowbrook, IL (US)

(72) Inventor: Kishore Swaminathan, Willowbrook, IL (US)

(21) Appl. No.: 19/431,899

(22) Filed: Dec. 23, 2025

Related U.S. Application Data
(63) Continuation-in-part of application No. 19/260,397, filed on Jul. 4, 2025.
Application No. 19/260,397 is a division of application No. 18/241,959, filed on Sep. 4, 2023, now Pat. No. 12,401,508.

(51) Int. Cl. H04L 9/30; H04L 9/08

(52) U.S. Cl. CPC H04L 9/30; H04L 9/0819; H04L 9/0894; H04L 61/4511; H04L 63/126

(57) ABSTRACT

A public key distribution framework for email addresses comprises Domain Key Authorities (DKAs) designated by Internet domains as authoritative managers of public keys of email addresses belonging to their respective domains. A root DKA (rDKA) anchored to a predetermined root domain serves as a wildcard authority for any email address. To guard against DNS-based attacks, DKAs and the rDKA register signing credentials with a DKA Trust Anchor (DTA). Clients verify signed DKA responses via the signing credentials held by the DTA. This two-layer architecture separates DNS-based service discovery from cryptographic verification, requiring attackers to compromise two independent layers to forge responses. When the DTA's domain is DNSSEC-protected, a single DNSSEC deployment extends cryptographic trust to all DKAs without per-domain DNSSEC. The architecture generalizes to a Domain Trust Propagation (DTP) pattern applicable to multi-domain service frameworks, enabling scalable DNSSEC-backed trust propagation with O(1) rather than O(n) deployment complexity.

### CROSS-REFERENCE TO RELATED APPLICATIONS

This application is a Continuation-in-Part of U.S. patent application Ser. No. 19/260,397, filed Jul. 4, 2025, which is a divisional of U.S. patent application Ser. No. 18/241,959, filed Sep. 4, 2023. The aforementioned applications are hereby incorporated by reference in their entirety.

### FIELD OF INVENTION

This invention is in the fields of cryptography and key management. Specifically, it provides systems and methods for securing a public-key infrastructure and service outputs.

### BACKGROUND

Public key cryptography forms the basis for secure communication across the Internet, yet there are no widely adopted, scalable mechanisms for the distribution and lookup of users' public keys to enable user authentication or to initiate encrypted communication with a user. Email solutions such as s/MIME (Secure/Multipurpose Internet Mail Extensions) rely on certificate authorities to certify the binding between email addresses and public keys, while OpenPGP (Pretty Good Privacy) uses webs of trust where email addresses certify each other, but neither provides a reliable key distribution or lookup mechanism. Given that email addresses have become de facto identifiers for people for signing into applications ranging from corporate systems to social media, banking, e-commerce, and crypto wallets, a public key framework for the email address namespace has wide-ranging applications in encrypted email, instant messaging, user authentication, document attestation, and cryptocurrency wallets.

In a parent application, we described a Domain Key Authority (DKA) framework in which an Internet domain may designate a domain-specific DKA as an authoritative collector and distributor of public keys of email addresses belonging to that domain. DKAs are discovered via Domain Name System (DNS) records at their respective domains, collect and validate the binding between email addresses and their asserted public keys using an email verification scheme, and serve public keys to clients over Application Programming Interfaces (APIs). The framework also provides a root DKA (rDKA) as a fallback key authority to cater to any email address, even if its domain does not have a DKA. The rDKA is discoverable through the DNS at a predetermined and well-known domain, thereby yielding a deterministic lookup path for public keys associated with any email address. FIG. 03 depicts an embodiment of the DKA framework: domains designate their DKAs, and the predetermined root domain designates the rDKA.

Like any system that discovers services through DNS, the DKA framework has a known attack vector: if an attacker compromises a domain's DNS records, queries intended for that domain's DKA can be redirected to a service controlled by the attacker. Such a service can present forged keys while still appearing as a legitimate DKA. Transport Layer Security (TLS) may not prevent this attack in common deployments, as both discovery and server authentication rely on the same DNS name. An attacker with DNS control can obtain a valid TLS certificate for the DKA's domain through mechanisms that verify domain control using DNS challenges. TLS will then successfully authenticate the attacker's server based on hostname matching. Since the TLS certificate is bound to the same DNS name used for discovery, clients get no independent assurance that the DKA and the keys it serves are legitimate.

Although DNS Security Extensions (DNSSEC) can cryptographically protect such DNS records, widespread per-domain DNSSEC deployment remains impractical at Internet scale due to its operational complexity, key-management burden, and historically low adoption rates. Relying on every domain to deploy and maintain DNSSEC correctly is therefore not a viable mitigation strategy for DKA-like frameworks that must serve thousands or millions of domains.

This continuation-in-part extends the parent framework in two principal respects. First, it introduces a DKA Trust Anchor (DTA) —a cryptographic anchoring service that acts as a root of trust for a DKA framework, providing cryptographic verification for DKA and rDKA responses independent of DNS-based discovery and transport-layer security. Second, it generalizes the anchoring mechanism into a scalable Domain Trust Propagation (DTP) scheme that decouples service discovery from verification and: (a) applies the same trust-anchoring concept to a broad range of domain-designated services beyond DKAs, and (b) enables DNSSEC-secured trust established at a single anchor domain to be securely and efficiently propagated to large numbers of related domains, improving the scalability of DNSSEC-backed trust without requiring DNSSEC deployment at every participating domain.

### BRIEF DESCRIPTION

A DKA Trust Anchor (DTA) is a cryptographic anchor that acts as a root of trust for DKAs and the root DKA (rDKA). DKAs register signing credentials with the DTA, and clients verify signed DKA responses using verification material obtained from the DTA, so that compromise of DNS records that designate a DKA is no longer sufficient to forge authoritative responses, even when individual DKA domains do not deploy DNSSEC.

In various embodiments, the DTA verifies DKA signing authorities using the same email-verification scheme that DKAs use to verify end-user mailbox ownership. For example, a domain-level DKA designates a signing-authority address (e.g., dka@dka.example.com), and the DTA verifies the signing authority's control of this address through email challenge-response and, optionally, proof of private-key possession. Upon successful verification, the DTA registers the signing credential. The DKA uses the corresponding private key to digitally sign API responses, and clients obtain verification material from the DTA to validate those signatures.

This creates a two-layer defense. A discovery layer uses DNS to locate DKAs (e.g., clients resolve _dka.example.com for domain-level DKAs or query a predetermined domain for the rDKA), and a cryptographic anchoring layer uses the DTA to verify signed responses. Compromise of a DNS record may redirect queries to an attacker-controlled server, but such redirection cannot yield responses that validate against verification material from the DTA unless the attacker also compromises the DKA's signing private key or the signing-authority email account used to register the credential with the DTA—assets that are typically administered through systems and controls separate from the DNS records designating the DKA.

Client-server systems typically access APIs over TLS: DNS locates the server, and a Certificate Authority (CA) authenticates the server's hostname. While TLS may seem like two-layer security, in common deployments, it may not prevent this attack as both service discovery and server authentication rely on the same DNS name. An attacker with DNS control can obtain a valid TLS certificate for a DKA's domain through automated issuance mechanisms that verify domain control via DNS challenges. By contrast, in the DTA framework, subordinate services sign responses using credentials independent of their DNS records, and clients verify signatures using verification material from the DTA. As a result, DNS compromise for a subordinate domain may redirect a TLS connection but cannot cause attacker-generated responses to verify against DTA-provided credentials, because the cryptographic binding between identifiers and keys is enforced at the anchor layer rather than at the subordinate domain's DNS name.

The DTA itself is discovered through mechanisms independent of—and thus not vulnerable to compromise of—the DNS records used to designate individual DKAs. In some embodiments, the DTA location is hardcoded in client software (e.g., https://dta.org) or discovered via a DNSSEC-secured DNS record at a well-known domain. In others, multiple DTAs may be available at known locations, with clients configured to trust specific DTAs based on jurisdiction, organizational policy, or user preference. Additional embodiments provide alternative mechanisms for clients to authenticate the DTA, such as certificate-based attestation, challenge-response protocols, or transparency-log inclusion proofs, which may supplement or replace DNS-based discovery for high-assurance deployments.

The DTA anchoring mechanism described above represents a specific application of a more general architectural pattern that we call Domain Trust Propagation (DTP). In DTP, an anchor service maintains verification credentials for subordinate services operating at respective network domains. Subordinates register their credentials with the anchor through verification channels that are administratively and cryptographically independent of the DNS records designating those services. Subordinates then sign their outputs using the registered credentials, and clients verify those signatures using verification material obtained from the anchor. This separation of service discovery (via DNS) from cryptographic verification (via the anchor) guards against DNS-based attacks, and the pattern is applicable to other multi-domain service frameworks, including certificate-transparency ecosystems, federated identity systems, IoT device attestation frameworks, blockchain oracle networks, and content-delivery networks.

Further, when the anchor domain is secured by DNSSEC, clients authenticate the anchor via DNSSEC validation, and cryptographic trust propagates through the chain: DNS root→anchor domain (via DNSSEC validation)→anchor-provided credentials (via anchor API or DNS)→subordinate outputs (via signature verification). This enables end-to-end cryptographic integrity and authenticity from the DNS root, through the anchor, to services at domains that do not deploy DNSSEC. By localizing DNSSEC deployment at a single anchor and propagating trust to subordinates, the DTP architecture provides DNSSEC-backed assurances with O(1) deployment complexity rather than O(n) (DNSSEC at each subordinate), substantially improving operational scalability. This addresses the complexity, key-management burden, and low adoption challenges that make per-domain DNSSEC impractical at Internet scale.

### LIST OF FIGURES

FIG. 01: DNS entries of an example domain showing how DKAs are defined.

FIG. 02: A pictorial view of the DNS entries shown in FIG. 01.

FIG. 03: A schematic showing multiple DKAs along with the root DKA (rDKA).

FIG. 04: A schematic showing a DKA framework anchored on a DTA.

FIG. 05: A schematic of a client verification flow under the DTA-anchored DKA APIs.

FIG. 06: A pictorial depiction of how DTA is anchored to DNS through DNSSEC.

FIG. 07: A pictorial view of verification flow with a DNSSEC-anchored DTA.

FIG. 08: An example of a signed registration receipt from a DKA.

FIG. 09: A schematic of a DKA's tamper-evident log anchored to DTA.

FIG. 10: A pictorial depiction of how DTP enables a 2-layer architecture.

FIG. 11: A pictorial depiction of DNSSEC trust propagation in DTP architecture.

FIG. 12: A pictorial depiction of DTP embodiments A, B, and C.

FIG. 13: A pictorial depiction of DTP-based Certificate Transparency Verification.

### DETAILED DESCRIPTION

### 1. Background: The DKA Framework

First, we summarize the DKA framework of the parent application as background for the current disclosure. The DKA framework provides a distributed, DNS-anchored public key infrastructure for email addresses, where each domain (e.g., example.com) may designate a Domain Key Authority (DKA) as an authoritative manager for the collection and distribution of public keys of email addresses belonging to the domain (i.e., addresses ending @example.com).

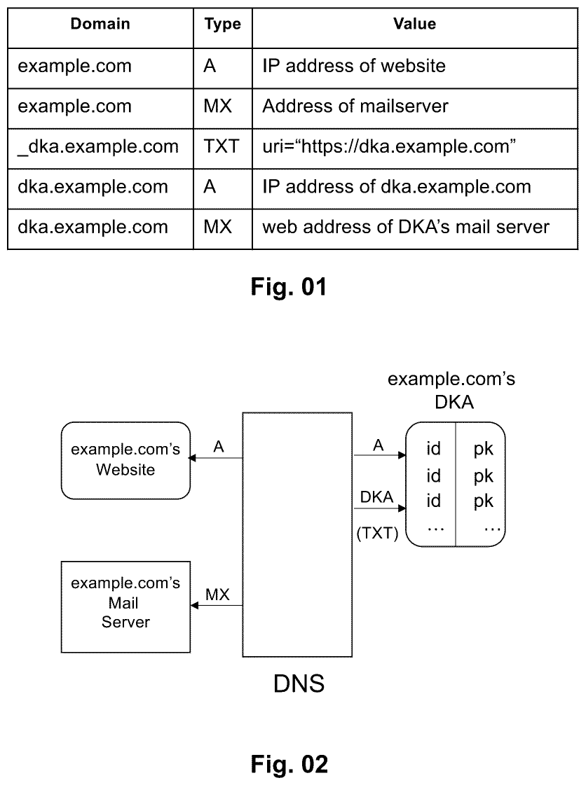

DKA Designation and Role: As shown in FIGS. 01 and 02, a domain (e.g., example.com) designates, via a DNS record, its DKA through a DKA locator record (e.g., a TXT record at a predefined subdomain _dka.example.com and a network location for accessing the DKA). The DKA may be implemented as any network-accessible service using any suitable protocol.

Key Collection and Verification: To register a public key with a DKA, a user may email the public key from their email account—known as the submission email address (SEA) —to the DKA's designated mailbox (e.g., dka@dka.example.com). The DKA verifies the SEA through one or more validation mechanisms. These may include Domain Key Identified Mail (DKIM) signature validation on the submission email, challenge-response verification in which the DKA sends a unique token to the SEA and receives a response proving mailbox control, proof of possession of the private key by successfully answering a cryptographic challenge, or a multi-factor authentication associated with the SEA.

Selectors and Metadata: An email address may register multiple public keys with its DKA, with each key distinguished by a selector label (such as “default”, “signing”, “auth”) enabling different keys for different purposes. Each registered key may be associated with metadata in the form of key-value pairs, which can include attributes such as key type, key length, algorithm, expiration dates, fingerprints, and other application-specific properties.

Key Distribution via API: The DKA provides a public API through which clients query for public keys. For example, an API request https://dka.example.com/api/get-key?email=alice@example.com&selector-auth may be used to retrieve Alice's authentication key. If an appropriate key is registered, the DKA returns the key along with any metadata. In some embodiments, DKA APIs are open and public, enabling use cases such as encrypted email (so a sender can retrieve any recipient's public key), challenge-response authentication (so a website retrieves a user's “auth” key to verify a signed response), or cryptocurrency payments (so a payer retrieves a payee's payment address published under an appropriate selector). In some embodiments, the DKA may provide additional metadata via authenticated APIs.

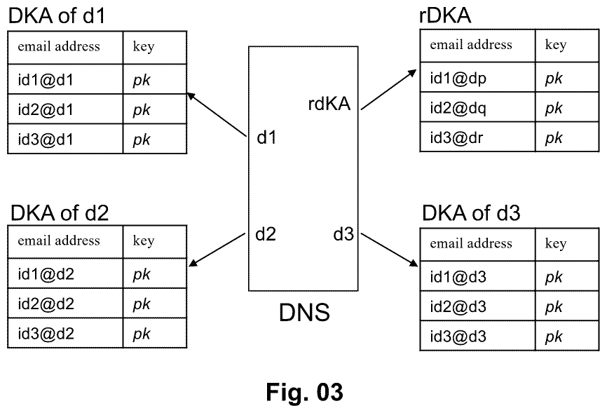

The Root DKA (rDKA): As shown in FIG. 03, the framework includes a root DKA (rDKA) associated with a well-known domain (e.g., rootdka.org). The rDKA serves two functions. First, it acts as a fallback authority for any email address to register and distribute its public keys, even if its domain does not have a designated DKA of its own. Second, it functions as a search root: when a client queries a domain-level DKA for the public key of an email address and a key is not found, the search may proceed to the rDKA to find if a key has been registered there. In some embodiments, the search ends deterministically: either a key is found in the DKA or rDKA, or the email address does not have a public key registered in the framework.

From an operational perspective, the rDKA functions similarly to a domain-level DKA—it accepts registrations via a SEA, verifies the SEA using the same mechanisms as DKAs, and serves keys via the same API—except that it accepts registrations for email addresses from any domain rather than a specific domain. This makes the DKA framework universal: any user with an email address can participate, regardless of whether their domain has implemented a DKA.

### 2. DTA: Cryptographic Anchoring for DKA Framework

The DKA framework described in the parent application provides a decentralized architecture for public key distribution, where each domain designates its own key authority through DNS, and each DKA verifies the binding between email addresses and their public keys through email-based challenge-response mechanisms. The framework functions correctly so long as the DNS records that designate DKAs accurately reflect the legitimate designations made by their domains. However, the DNS itself is an old technology that predates modern security requirements and remains vulnerable to various forms of attack, including cache poisoning, man-in-the-middle interception, and unauthorized modification of zone files.

Although DNS Security Extensions (DNSSEC) address these vulnerabilities via cryptographic signatures to DNS records, DNSSEC adoption has been slow and uneven: it is operationally complex, requires considerable skill, and is known to be error prone. Relying on every domain to deploy and maintain DNSSEC correctly is therefore not a viable mitigation strategy for DKA-like frameworks that must serve thousands or millions of domains.

This continuation-in-part application proposes an enhancement to harden the DKA framework against DNS-layer attacks by leveraging the DKA's own mechanisms in a new way. Specifically, the enhancement introduces a DKA Trust Anchor (DTA) that applies the same email verification scheme used by DKAs to verify user public keys but applies the scheme to verify signing credentials of DKAs themselves. This iterative application of the framework's core mechanism makes DTA a cryptographic root of trust for an entire DKA framework.

The DTA operates as a distinct service, independent of domain-level DKAs and the rDKA. In some embodiments, the DTA is designated by a different domain than the domain designating the DKAs and rDKA, ensuring organizational and cryptographic separation between the DTA and the DKAs and rDKA it validates. Clients establish initial trust in a DTA through predetermined bootstrap mechanisms that are independent of the DNS records used to designate individual DKAs. For example, the network location of the DTA may be distributed with client software, published in jurisdictional trust lists, or secured by DNSSEC at a well-known domain.

In some embodiments, multiple DTAs may be available at recognized addresses, with clients configured to trust a specific set of DTAs according to organizational policy, jurisdiction, or user preference. These bootstrap mechanisms ensure that clients can reliably obtain the signing credentials of DKAs and rDKA from an authentic DTA source, providing a trusted foundation for verification of signed API responses.

### 2.1 DKA Registration as Signing Authority (SA)

In various embodiments, a domain-level DKA designates a signing authority (SA) —typically an email address under its control (e.g., dka@dka.example.com) —to digitally sign the DKA's outgoing API responses. The DKA generates a public-private key pair for this SA and registers the public key with the DTA using the same email verification scheme that DKAs employ for ordinary user registrations. The DKA sends an email from the SA email address containing the signing public key to the DTA, which validates control of the SA email address through mechanisms including, but not limited to, DKIM verification, challenge-response, or proof of possession of the corresponding private key.

In some embodiments, all DKAs use a canonical email address format to serve both as the SA and as the submission endpoint for key operations. For instance, the canonical address for example.com may be dka@dka.example.com, where the local part is a predetermined identifier (e.g., ‘dka’), and the domain part is a subdomain under DKA's domain (e.g., dka.example.com).

A DKA submits a public key associated with its SA email address from the SA email address's account to the DTA, which verifies the email address's binding to its public key in a manner similar to how DKA verifies the public key-email binding of email addresses (though embodiments may use additional or stricter verification criteria than DKA verification). Once verified, the DTA stores the public key of the SA email address, which clients can use to verify SA signatures on API payloads received from a DKA. The rDKA, functioning as a wildcard DKA, likewise registers its SA (e.g., rdka@rdka.org) with the DTA, much like other DKAs.

In alternative embodiments, a DKA may designate one or more different email addresses as SAs or submission endpoints and may publish such designations via a DKA discovery API or metadata provided by the DTA. The canonical DKA email address example described above is illustrative and not limiting; any deterministically or explicitly designated email address for the DKA may serve as its SA.

An architectural insight of this enhancement is that the DTA is operationally analogous to other DKAs within the framework: it receives emails containing public keys, verifies the sender's control of the email address through similar email verification mechanisms (DKIM validation, challenge-response, proof of possession of private key, etc.), and stores the verified public keys for distribution via its API. The difference is that while ordinary DKAs verify and store public keys for end users (e.g., alice@example.com), the DTA verifies and stores signing credentials of signing authorities of DKAs (e.g., dka@dka.example.com, rdka@rdka.org). This iterative application of the framework's core verification mechanism—using email verification to establish trust at each level—creates a hierarchical chain of trust without requiring different verification technologies or external certificate authorities.

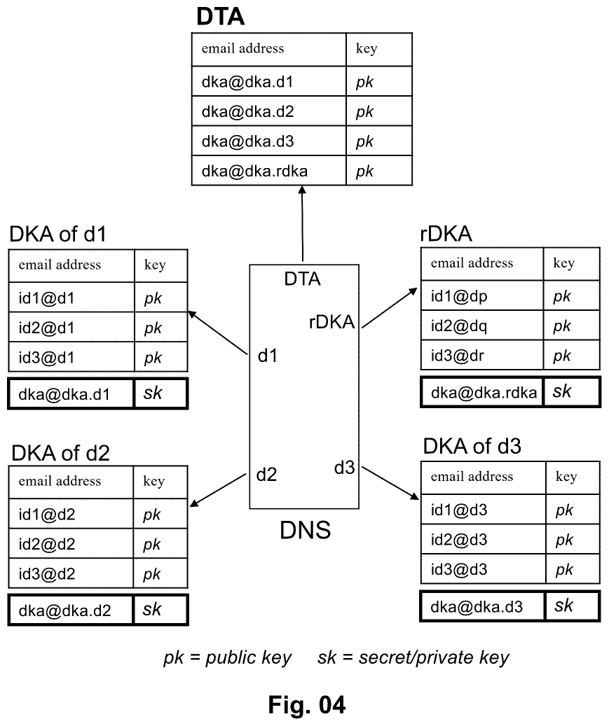

FIG. 04 depicts a DKA framework from an embodiment. SAs of individual DKAs (including rDKA) have a public key pk registered with the DTA via the same verification mechanism that the DKAs use to register end-user public keys. The DKAs hold corresponding private signing keys sk to digitally sign their API responses, which clients verify using the public keys obtained from the DTA. Thus, the DKAs are cryptographically anchored at the DTA: clients can verify if a DKA is genuine by validating signatures against public keys in the DTA.

### 2.2 Iterative Email Verification Process

The iterative email verification process described above may be referred to as the Email-Verified Cryptographic Anchor (EVCA) scheme. A distinguishing feature of the EVCA scheme is that it iteratively applies substantially identical email verification procedures at multiple hierarchical levels within the framework.

When an end user (e.g., alice@example.com) registers a public key with a DKA, the DKA verifies the user's control of the mailbox through DKIM validation, challenge-response, or proof of private key possession. When a DKA's SA (e.g., dka@dka.example.com) registers a signing credential with the DTA, the DTA applies similar email verification procedures to verify the SA's control of the SA mailbox.

This iterative application of email verification creates embodiments having a uniform trust model across the framework which does not require heterogeneous verification technologies at different levels (such as certificate authorities for one layer and email verification for another), nor does it depend on external trust infrastructure. Instead, it leverages the email system's own authentication mechanisms to establish trust at each level, from end users through DKAs to the DTA. This approach distinguishes the EVCA scheme from traditional PKI architectures that typically employ different verification mechanisms at different levels of the trust hierarchy.

While EVCA simplifies multi-level verification, an embodiment may use other mechanisms for the DTA to verify and register DKA signing credentials, if the mechanism establishes a credible and trusted binding between a DKA's SA and its signing credential so that clients can rely on the DTA-DKA verification chain to validate signed DKA responses.

Alternative mechanisms may include, but are not limited to, certificate-based attestation, hardware security module verification, multi-party authentication protocols, cryptographic proof of control over the DKA's network location, inclusion proofs in distributed ledgers, or any combination thereof. An essential architectural property is that the DTA provides a trusted anchor independent of the DNS-based discovery for clients to validate DKA signatures.

### 2.3 Signed API Responses

Once a DKA has registered its SA public key with the DTA, the DKA uses the corresponding private key to sign API responses it serves to clients. In some embodiments, the signed payload may include: (i) the email address being queried, (ii) the selector, (iii) the public key and associated metadata for that email address and selector, (iv) a version identifier for the public key, (v) a timestamp, and (vi) the identity of the SA (e.g., dka@dka.example.com).

The complete response returned to the client includes both the payload and the signature in any structured data format (e.g., JavaScript Object Notation (JSON), BSON (Binary JSON), Protocol Buffer (Protobuf), etc.). Below is an example response from an embodiment:

| | |
|---|---|
| { | “email”: “alice@example.com”, |
| | “selector”: “auth”, |
| | “public_key”: “MIIBIj9AAOCAQBCgKCAQEA...”, |
| | “key_type”: “RSA-2048”, |
| | “version_id”: 42, |
| | “timestamp”: “2025-11-13T10:30:00Z”, |
| | “signed_by”: “dka@dka.example.com”, |

| | |
|---|---|
| “signature”: “a7f3b9a2b2a48d0e2f4...” | } |

The inclusion of the email address in the signed payload ensures that the signature binds the public key to the specific identity being queried (e.g., alice@example.com). This prevents substitution attacks where an attacker might attempt to present a legitimately signed key for one user as if it belonged to a different user. The version identifier allows clients to track key versions and detect rollback attacks where an attacker attempts to serve an outdated key version. Clients can maintain the highest version number seen for an email address and its selector and reject responses with lower version numbers. The timestamp provides freshness so clients can reject stale or suspiciously old responses to mitigate replay attacks.

### 2.4 DTA Bootstrap and Client Authentication

In various embodiments, the DTA, which serves as an anchor for verifying DKA responses, is discovered independently of the DNS records that designate individual DKAs. The DTA's domain name is typically predetermined (for example, dta.org) and known to DKAs and their clients. DTA discovery and authentication can be realized in different ways, depending on deployment and security requirements, including but not limited to:
DNSSEC-protected DTA domain: In some embodiments, the DTA's domain is secured with DNSSEC, and clients validate its DNSSEC records before establishing TLS or other application-layer connections. This reduces DNS-based risk associated with DTA discovery.
DNSSEC-published DTA key: In some embodiments, the DNSSEC-protected DTA zone publishes a DNS record (e.g., TXT or TLSA) identifying a DTA public key. A DNSSEC-validating client resolves the record, verifies DNSSEC signatures, and extracts the DTA public key as a trusted key for later verification and validation of DTA-signed responses.
DNS+TLS: In some embodiments, the DTA is discovered via DNS, and the client connects to the DTA via TLS using a PKI-issued certificate. Although this inherits TLS's sensitivity to DNS attacks, an attacker forging DKA responses must compromise DNS for both the DTA domain (to impersonate the DTA and present forged credentials) and the DKA domain (to redirect queries), which is significantly harder than compromising either alone.
Out-of-band key provisioning: In some embodiments, the DTA's public key or certificate is provisioned through non-DNS channels such as client software distribution, certificate pinning, OS trust stores, or a logged key hash. Clients authenticate the DTA by verifying that its key or certificate matches the provisioned or logged trust anchor.

### 2.5 Client Verification Flow

To find the public key for alice@example.com with selector ‘auth’, a client first performs a DNS lookup for the DKA locator at example.com (e.g., _dka.example.com) and gets, say, dka.example.com. The client then sends an API request: GET https://dka.example.com/api/get-key?email=alice@example.com&selector-auth. The DKA returns a response containing Alice's authentication public key, the response signed with the DKA's SA's private key.

Upon receiving the signed response, the client extracts the SA identifier from the response (e.g., dka@dka.example.com) and queries the DTA at its known address (say, https://dta.org) for the SA's signing public key: GET/api/get-key/email-dka@dka.example.com &selector=signing. The DTA returns the signing public key associated with the DKA's SA. The client uses this public key to verify the signature on the DKA's API response.

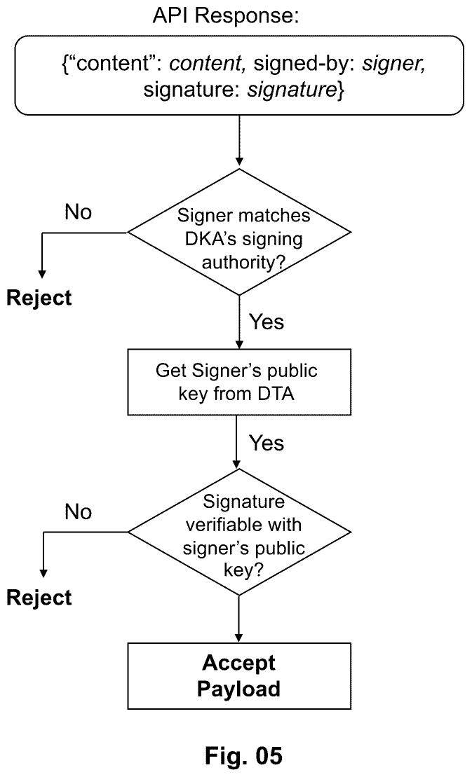

FIG. 05 depicts the verification flow. If verification fails, the client may reject the response. Signature validation failure indicates the response was not signed by the claimed DKA or was tampered with in transit. Absence of a registered signing public key at the DTA suggests the DKA has not properly registered, or the response is forged. These cryptographic checks provide strong assurance of response authenticity even if DNS records have been compromised.

### 2.6 Security Analysis

This two-layer verification architecture substantially hardens the DKA framework against DNS-based attacks, as an attacker has to compromise multiple independent systems to execute a successful attack. As discussed above, TLS may not prevent this attack as both discovery and authentication depend on the same DNS name, and attackers with DNS control can obtain valid TLS certificates through automated domain-control verification. With the cryptographic anchoring enhancement, however, the attacker's ability to redirect DNS is insufficient. Even though the attacker can cause clients to send their queries to the attacker's server, the attacker cannot produce responses that satisfy the cryptographic verification requirements imposed via the DKA Trust Anchor (DTA).

Specifically, the attacker-controlled server would need to provide responses signed with a private key corresponding to a signing public key registered at the DTA for a SA associated with example.com. The legitimate dka@dka.example.com public key is registered at the DTA and corresponds to a signing private key held by the legitimate DKA, not by the attacker. To forge valid signatures, the attacker would need to compromise (i) the DKA's signing private key, (ii) the email account dka@dka.example.com and register a new signing public key with the DTA, or (iii) the DTA itself to alter the DKA's signing public key registered with the DTA.

Each attack requires intrusion into systems and administrative domains independent of the DNS infrastructure of example.com. DNS records for example.com are usually managed by domain operators or hosting providers, the signing key by the DKA infrastructure team, while the domain's email administrators control the SA's mailbox. The DKIM signature originates in an email server from an entirely different DNS zone, likely hosted by a third-party email provider. The DTA itself may be operated by an independent trust service. Because each of these are administratively distinct, an attacker who compromises DNS records must also compromise the DKA's signing private key, the signing authority mailbox, or the DTA's registry. The separation of control significantly increases the difficulty of a successful attack, requiring compromise across multiple systems rather than exploitation of a single DNS weakness.

This defense-in-depth architecture thus requires an attacker to succeed in at least two independent attacks to forge public keys: compromising the DNS layer and compromising either the DKA signing private key or its registered signing public key at the DTA. By raising the bar from a single point of compromise to two independent compromises, the framework increases the difficulty of successful attacks substantially, even without universal DNSSEC deployment.

In deployments where DKA signing keys are managed under security controls separate from the DKA's database of public keys of user email addresses (for example, using hardware security modules), DTA anchoring provides another layer of protection against application-layer compromises. An attacker who gains access to the DKA's database and tampers with stored public keys cannot access the signing key to produce responses that verify under the signing authority credential registered at the DTA, limiting the impact of database-level compromises.

To maintain security, in some embodiments, the framework supports key rotation and revocation. DKAs and rDKAs periodically update credentials via the DTA and clients use version identifiers and transparency logs to verify changes. If a key is compromised, the framework recovers by propagating new credentials through the DTA.

### 2.7 DNSSEC Integration

In some embodiments, the DTA's domain may be secured with DNSSEC, allowing DNSSEC-validating clients to authenticate the DTA's network location before querying the service. For example, if the DTA operates at dta.org and dta.org deploys DNSSEC with key signing and zone signing infrastructure, clients and resolvers can verify the DTA's authenticity. When combined with the DKA signing mechanism, a DNSSEC-protected DTA creates a complete cryptographic chain from the DNS root to retrieved user public keys: DNSSEC anchors the DTA to the DNS root, the DTA anchors DKAs' signing credentials, and DKA signature anchors individual public keys of user email addresses.

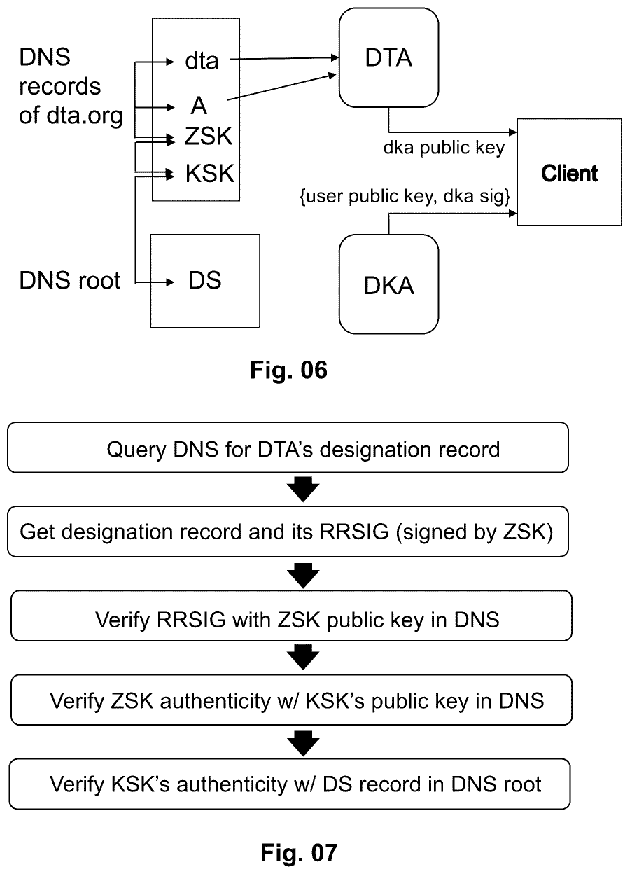

FIG. 06 shows the DNSSEC records securing the DTA's domain: the domain designation is signed with a Zone Signing Key (ZSK), which is signed with a Key Signing Key (KSK), which is anchored at its root with a Delegation Signer (DS) record. A client can verify a user public key based on the DKA's signature, which is anchored to the DKA's public key in the DTA, providing end-to-end cryptographic link from the DNS root to a public key. FIG. 07 shows client verification steps to validate the DTA's DNS records through the DNSSEC chain of trust.

### 2.8 Signed Registration Receipt for a Public Key

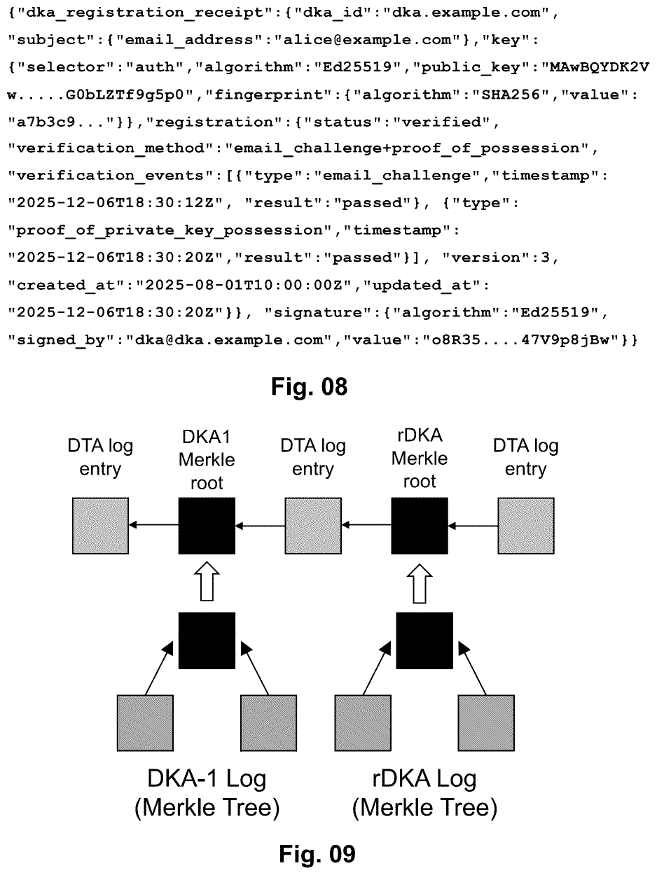

In some embodiments, upon registration of a public key for an email address, a DKA issues a signed receipt confirming the registration. The receipt contains details on when and how the DKA verified the binding between the email address and a public key. The receipt enables relying parties to verify that an email address is registered (via the DTA-DKA trust chain). Because the receipt is signed and time-stamped, the DKA cannot plausibly deny the verification event, and the user can prove to a relying party that the DKA verified its public key. A DKA registration receipt from an embodiment shown in FIG. 08 includes (i) a DKA identifier; (ii) the subject email address; (iii) registered public key and its attributes; (iv) registration metadata including verification status, verification methods, timestamps, and version information; and (v) a digital signature computed by the DKA over the receipt contents. In some embodiments, the DTA issues similar signed receipts to DKA Signing Authorities (SAs).

Signed registration receipts enable users to demonstrate that they control a public key as verified and certified by a DKA. In some embodiments, both the DKA and the user may independently record registration receipts in tamper-evident logs, creating verifiable, non-repudiable records that survive even if the DKA's database is later compromised. Such receipts may be particularly valuable in low-connectivity or offline scenarios (user offline, DKA unreachable, DTA unreachable) for a user to show that the binding between their email address and public key is valid, as certified by a DKA, and verifiable through the DKA-DTA path.

Registration receipts may also satisfy regulatory or audit requirements in environments such as financial services, healthcare, and government systems. In embodiments where compatibility with existing certificate-based protocols is desired, a DKA's registration receipt may function as a certificate: the DKA (and DTA) may encode the receipt in X.509 format (with DKA as issuer and the user's email address as subject), effectively operating as a Certificate Authority within the DKA framework. Receipts may include expiration timestamps and can be revoked through signed revocation receipts if needed. For high-assurance use cases, relying parties may additionally query the DKA or consult a transparency log to confirm that a key referenced in a receipt has not subsequently been revoked.

### 2.9 Tamper Evident Logging—DTA as Transparency Anchor

Each DKA maintains an append-only log recording all key operations (registrations, updates, revocations etc.). Log entries are linked through hash chains or Merkle tree structures with each entry including a hash of the previous entry, making any alteration cryptographically detectable. Each log entry records the operation details (email address, selector, operation type, timestamp) and links to the previous entry, ensuring that observers can verify that the logged operations occurred in the claimed sequence and that no operations have been modified.

In some embodiments, each DKA periodically computes a state commitment reflecting its complete operational history and publishes the commitment to the DTA. For example, each DKA may compute a hash of its current log state (such as the Merkle root), sign this hash with its signing private key, and submit it to the DTA. The DTA records these state commitments in its own append-only log, creating a framework-wide transparency record. This makes the DTA both the cryptographic anchor for verifying DKA signatures and the transparency anchor that witnesses and records the state of all DKAs at regular intervals. If a DKA attempts to retroactively modify its operational history, the divergence between the DKA's current state and the state commitment previously published to the DTA becomes cryptographically detectable.

FIG. 09 depicts this logging architecture: each DKA maintains a Merkle tree of its operations and periodically publishes its Merkle root hash to the DTA's append-only log. The DTA log records both DKA state commitments and the DTA's operations, creating a complete, framework-wide record that makes tampering cryptographically detectable. In one embodiment, the DTA's log is published as a Certificate Transparency-style log or anchored in a public transparency ledger, so third parties can audit and detect hidden revocations or rollbacks.

In some embodiments, each email-public key binding is accompanied by verification provenance data (e.g., mechanisms used for verifying the binding) and key rotation history (e.g., version identifiers and timestamps). A DKA may include portions of this provenance data in its signed API responses, enabling clients to assess the assurance level of a reported key.

### 2.10 Alternative Embodiments

Multiple Trust Anchors: In addition to the single global DTA described above, some embodiments support a plurality of DTAs to satisfy operational, jurisdictional, performance, or structural requirements. Regional/jurisdictional DTAs may be operated to meet data-sovereignty requirements, reduce latency, or align with local policy. Examples include eu.dta.org (Europe), na.dta.org (North America), fr.dta.fr (France), etc. Structural DTAs may mirror the DNS hierarchy itself. In some embodiments, each top-level domain (TLD) hosts its own DTA at a well-known location within the TLD namespace (e.g., tld-dta.com for .com, tld-dta.org for .org, tld-dta.fr for .fr). DKAs under a given TLD may register their signing credentials with that TLD's DTA, preserving administrative and governance alignment with existing DNS delegation.

Clients may be configured to discover the appropriate DTA automatically from the domain name of the DKA being verified (e.g., by constructing tld-dta. from the domain's TLD) or via a statically distributed policy file. In federated deployments, a client may consult multiple DTAs (e.g., both a regional DTA and a TLD-specific DTA) and accept a DKA signing credential if it is registered with any trusted DTA, or if it satisfies a configurable quorum.

Signing Certificates: In some embodiments, some or all DKAs may use certificates (for example, X.509 certificates) issued to the DKA or the DKA's signing authorities. These certificates may be issued by Certificate Authorities and verified using standard PKI certificate chain validation against trusted root CA certificates distributed with client software or operating systems. This approach leverages existing trust infrastructure and is particularly suitable for enterprise deployments where organizations already maintain TLS certificates for their domains. Alternatively, certificates may gain their legitimacy through registration at predetermined anchor locations, such as being displayed in a DNS record at the DTA's domain as _dka_certificate.example.com TXT “dka=dka.example.com; cert=xxxxxxx” or via API (e.g., https://dta.org/api/get-certificate?dka=dka.example.com).

Threshold-based anchors: In some embodiments, the cryptographic anchoring layer comprises multiple independent anchor entities, and a client accepts a DKA's signing authority only if a threshold number (such as “at least two” or “at least two-thirds”) of anchors provide consistent key bindings for the DKA, thereby further increasing robustness against compromise of any single anchor. In other embodiments, the cryptographic anchors (public keys) at the DTA use out-of-band verification to establish binding to DKA signing keys.

Summary: These alternative embodiments show that the disclosed framework is not limited to the specific EVCA scheme but encompasses architectures that provide cryptographic verification of DKA responses through anchor entities whose trust is independent of DKAs and the DNS records that designate them. A core architectural principle is the separation of the discovery layer (DNS-based DKA location) from the cryptographic anchoring layer (DTA-based signature verification). Discovery uses DNS records to locate DKAs, a mechanism susceptible to DNS hijacking. The cryptographic anchoring layer relies on a DTA or equivalent trust root that is established via stronger or independent mechanisms (e.g., hard-coded URLs, or distribution lists, a well-known DNSSEC-protected domain) independent of DKAs. In such designs, an attacker seeking to serve forged public keys must subvert both the DNS-based discovery layer and the cryptographic anchoring layer, significantly raising the bar for successful attacks.

### 3. Domain Trust Propagation (DTP): Cryptographic Anchoring Beyond the DKA

The DKA Trust Anchor (DTA) described in Section 2 represents a specific instance of a more general architectural pattern that we call Domain Trust Propagation (DTP). DTP extends cryptographic trust from a single anchor to subordinate services across multiple domains, providing defense-in-depth against DNS attacks while enabling DNSSEC-like benefits without per-domain DNSSEC deployment.

In DTP, an anchor service maintains verification credentials for subordinate services that operate at other domains. Subordinates register credentials with the anchor through channels that are administratively independent of their DNS records, sign their outputs using the registered credentials, and clients verify those outputs using anchor-provided credentials.

This separation of service discovery (via DNS) from cryptographic verification (via the anchor) provides two complementary mechanisms:
Part I: Cryptographic Anchoring guards against DNS-based attacks by ensuring that compromise of a subordinate's DNS records alone cannot forge verifiable outputs. This mechanism functions without requiring DNSSEC at any subordinate domain.
Part II: When the anchor domain is DNSSEC-protected, DTP extends DNSSEC-derived trust from one anchor domain to subordinates at multiple non-DNSSEC domains. Clients authenticate the anchor via DNSSEC validation and the subordinate's services via anchor-provided credentials, creating an end-to-end cryptographic chain from the DNS root through the anchor to subordinate's services, with O(1) DNSSEC deployment at the anchor rather than O(n) deployment at subordinate domains.

The DKA framework with DTA is one embodiment of DTP. This section demonstrates DTP's generality describes three embodiments of DNSSEC trust propagation with different operational trade-offs.

### 3.1 Part I: Cryptographic Anchoring for Service Frameworks

Many distributed service frameworks use DNS to designate service locations. An attacker who compromises DNS records can redirect clients to attacker-controlled servers. While DNSSEC addresses this vulnerability, DNSSEC adoption has been slow and uneven due to DNSSEC's operational complexity and error prone nature, leaving most frameworks vulnerable.

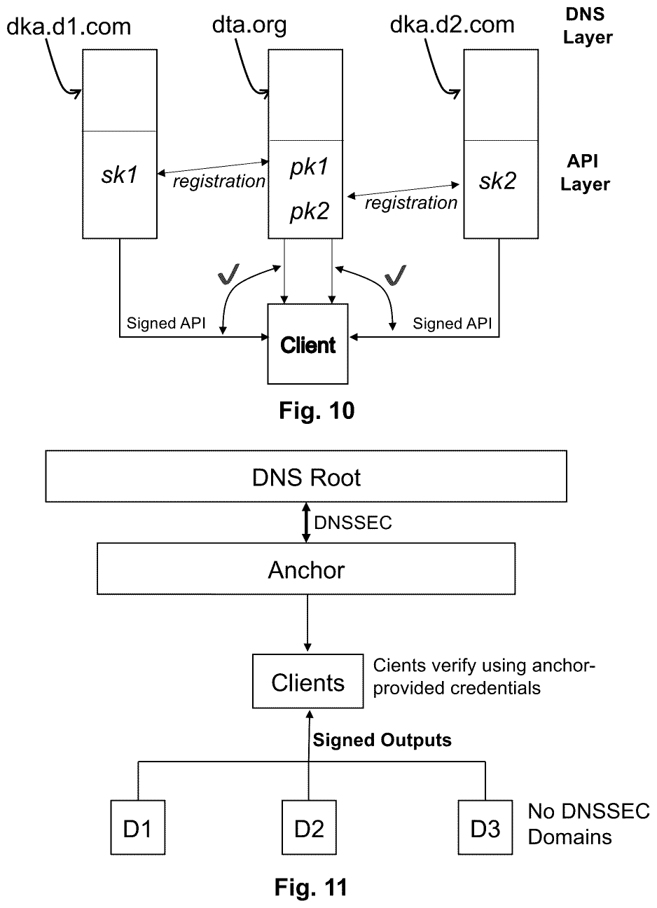

DTP provides a solution against most DNS attacks by separating service discovery from cryptographic verification. As shown in FIG. 10, DTP comprises: an anchor service at a predetermined location (e.g., dta.org) maintaining a registry of verification credentials (public keys, certificates, or other cryptographic material, e.g., pk1, pk2) for subordinates; subordinates at respective domains, each with a designated signing authority and signing key (e.g., sk1, sk2); a registration mechanism via channels (email verification, certificate attestation, out-of-band verification, authenticated APIs, etc.) that provide administrative separation from DNS service designation records; signed responses from subordinate services using registered credentials; and a client verification flow to validate signed responses against the anchor-registered credentials.

An attacker who compromises a subordinate domain's DNS can redirect service discovery but cannot forge responses that verify against anchor-distributed credentials without also compromising the service's signing key, the registration channel, or the anchor itself—each involving independent systems and administrative domains. FIG. 10 depicts this architecture with a DNS discovery layer and the cryptographic anchoring layer via signed API responses.

This pattern is generalizable: (a) establish an anchor service at a known location; (b) separate the registration protocol from DNS designation; (c) require subordinates to sign outputs; (d) enable clients to obtain verification credentials from the anchor; and (e) enable cryptographic verification of signed outputs. The unifying principle is architectural separation between discovery and verification to thwart a class of DNS attacks without DNSSEC protection.

### 3.2 Part II: DNSSEC Trust Propagation Via DTP

Part I described a version of the DTP architecture in which an independently discoverable domain protects subordinate services from DNS attacks without the need for DNSSEC. Part II describes a different version of the DTP architecture in which a DNSSEC-protected anchor enables a framework of subordinate domains to leverage the anchor's DNSSEC-based authentication through anchor-provided credentials (without deploying DNSSEC themselves).

As shown in FIG. 11, this architecture provides end-to-end cryptographic integrity and authenticity from the globally trusted DNS root through to service outputs at domains that do not deploy DNSSEC. The operational complexity of DNSSEC—key generation, key rotation, zone signing, DS record coordination with parent zones, and monitoring for validation failures—is localized to a single anchor domain rather than distributed across every participating service domain. For a framework with n subordinate services, DTP requires O(1) DNSSEC deployments (at the anchor) rather than O(n) DNSSEC deployments (at each subordinate domain). Below we describe three embodiments that implement this DNSSEC trust propagation in distinct ways.

### 3.2.1 Embodiment A: API-Based Trust Propagation

In a first embodiment, an anchor operates at a DNSSEC-protected domain and exposes an API through which clients obtain verification credentials for subordinate services. Clients authenticate the anchor via DNSSEC validation, query the anchor's API for a subordinate's credentials, and verify subordinate signatures using the API-provided credentials. This embodiment concentrates all credential distribution through a DNSSEC-validated API endpoint:
1. The anchor operates at a DNSSEC-protected domain (e.g., anchor.org) and maintains a registry of verification credentials for subordinate services across multiple domains (e.g., s1.d1.com, s1.d2.net, s2.d2.net, s3.d2.net/keys/api1/).
2. Each subordinate service registers a signing credential (public key, certificate, or other verification material) with the anchor using a registration mechanism independent of its own DNS records (email challenge-response, authenticated API, certificate attestation, or other out-of-band verification). A subordinate service may optionally register a signing authority (SA) associated with the signing credential.
3. The anchor stores a verified association between the subordinate-service identifier, its SA if any, and its signing credential.
4. A client wishing to verify a signed output from a subordinate:
   authenticates the anchor's domain via DNSSEC validation;
   obtains verification material for the subordinate from the anchor's API; and
   verifies the subordinate's signature using the anchor-provided material.

Shown below are a client API request and the anchor's response from an embodiment:

Request: GET https://anchor.org/api/v1/credentials?service=SRV1&domain=d1.com

| | |
|---|---|
| Response: { | “service”: “SRV1.d1.com”, |
| | “credential_type”: “ed25519_public_key”, |
| | “public_key”: “tbudgBSg+bHWHiHnlteMzN8TUvI80ygS9IULh4rklEw=”, |
| | “registered_at”: “2025-12-01T10:00:00Z”, |
| | “expires_at”: “2026-12-01T10:00:00Z” } |

Clients use DNSSEC once to authenticate the anchor, and all further trust is propagated via the anchor API. Subordinate domains need not deploy DNSSEC, and credential lifecycle operations (rotation, revocation, metadata updates) are managed through the anchor without modifying subordinate DNS zones. As shown in FIG. 11 cryptographic trust propagates through the chain: DNSSEC root→anchor domain (via DNSSEC validation)→anchor-provided credentials (via anchor API)→subordinate service outputs (via signature verification).

In some embodiments, the Domain Trust Propagation architecture supports multiple anchors, each operating at a predetermined, well-known location (e.g., anchor1.org, anchor2.org, tld-anchor.net) and secured with DNSSEC to enable cryptographic authentication via the global DNS root of trust. These anchors independently maintain registries of verification credentials for subordinate services across diverse domains. To further enhance resilience, clients may implement an m-of-n threshold scheme, accepting a credential binding only if at least m out of n trusted anchors provide consistent results for a given subordinate service identifier and its value.

### 3.2.2 Embodiment B: DNS-Based Trust Propagation

In a second embodiment, the anchor publishes verification credentials for subordinate domains directly in its own DNS zone as records protected by DNSSEC signatures, confining all DNSSEC-related operations to the anchor domain. In this embodiment, anchor discovery may occur through well-known anchor domains (e.g., publickey-anchor.org), configuration files (e.g., enterprise policy specifies internal anchor), or other out-of-band distribution method.

In one embodiment, when a subordinate service at domain d1.com registers a credential for service identifier SRV1, the anchor creates a DNS record containing the public key at _pubkey.SRV1.d1.anchor.org in the anchor's DNS zone, signs the record with the anchor's zone-signing key to produce an RRSIG, and publishes both records. Shown below are DNS records from an embodiment. The first record (TXT) contains the subordinate's public key. The second record (RRSIG) contains the anchor's DNSSEC signature over the TXT record:

_pubkey.SRV1.d1.anchor.org 3600 IN TXT “v=DTP1 k=ssh-ed25519
AAAAC3NzaC1lZDI1NTE5AAAAIOMqqnkVzrm0SdG6UOoqKLsabgH5C9okWi0dh2l9GKJl”
_pubkey.SRV1.d1.anchor.org. 3600 IN RRSIG TXT 15 5 3600 (

20251220000000 20251213000000 12345 anchor.org.
J3bWvqHVTE8W5zEqVJ7cWkGxP2nF5L8vM9QkR7sT4uV6
wX8yZ0aB1cD2eF3gH4iJ5kL6mN7oP8qR9sT0uV1wX2yZ )

Clients obtain the public key via standard DNSSEC resolution. Given a subordinate service SRV1 at domain d1.com and knowing the anchor domain is anchor.org, the client queries _pubkey.SRV1.d1.anchor.org for TXT records, receives both the TXT record and its RRSIG, validates the RRSIG using the anchor's DNSKEY record (obtained and authenticated via DNSSEC validation from the DNS root), and extracts the public key from the validated TXT record. The DNSSEC validation chain flows: DNS root→anchor.org's DS record→anchor.org's DNSKEY→RRSIG validates TXT record→public key extracted.

DNS-based public key discovery offers four primary benefits. First, it unifies verification via DNSSEC, reducing or eliminating the need for separate credential-retrieval APIs. Second, it leverages DNS caching and TTLs, allowing clients to verify signatures even during network partitions or anchor downtime. Third, it centralizes complexity by handling all DNSSEC operations at the anchor, eliminating DNSSEC overhead from subordinate domains. Fourth, it ensures transparency since DNS allows any party to detect credential changes and modifications.

Challenges include DNS record size limitations (addressed by compact keys such as Ed25519 public keys, or by publishing hashes or fingerprints rather than full keys), DNS propagation delays during credential rotation (addressed by short TTLs and grace periods), and the inherently public nature of DNS records (which is acceptable for verification credentials that are intended to be public, while access-control mechanisms are applied to credential registration and management APIs rather than to DNS lookups themselves).

DTP represents an architectural inversion relative to DANE (DNS-based Authentication of Named Entities): whereas DANE requires each service domain to deploy DNSSEC and publish TLSA records in its own DNS zone—an O(n) deployment model—DTP publishes credentials for subordinate services from multiple domains in a single DNSSEC-protected anchor zone (an O(1) deployment model). It still provides end-to-end integrity—from the DNS root through the anchor domain to subordinate service outputs—comparable to DANE without requiring per-domain DNSSEC deployment at each subordinate domain.

### 3.2.3 Embodiment C: Hybrid Trust Propagation

In Embodiments A and B, subordinate domains do not participate directly in establishing DNSSEC-based trust. Instead, DNSSEC overhead is localized in one well-managed anchor, allowing trust to propagate to numerous subordinate domains or services.

A third embodiment implements bidirectional verification through DNS records at both subordinate and anchor domains. A subordinate domain publishes its registration receipt in its own DNS zone, while the anchor publishes a fingerprint of that receipt in the anchor's zone. This creates a bidirectional attestation analogous to the DNSSEC DS/DNSKEY model, where parent zones publish DS records of child zone keys. Below are sample DNS records: the first is published by the subordinate (d1.com) and contains its identifier, public key, and the anchor's signature; the second is published by the anchor (anchor.org) and contains a hash of the subordinate's receipt, serving as the anchor's attestation:

_receipt.SRV1.d1.com IN TXT “v=DTP1 sub=SRV1.d1.com sel=default
alg=15 key=tbudgBSg+bHWHiHnlteMzN8TUvI80ygS9IULh4rklEw= ts=1734134400
exp=1765670400 sig=J3bWvqHVTE8W5zEqVJ7cWkGxP2nF5L8vM9QkR7sT4uV
6wX8yZ0aB1cD2eF3gH4iJ5kL6mN7oP8qR9sT0uV1wX2yZ”
_fp.SRV1.d1.anchor.org IN TXT “v=DTP1 hash=sha256
fp=7a3f8b2e9d1c4a5b6e8f0d2c3a4b5c6d7e8f9a0b1c2d3e4f5a6b7c8d9e0f1a2b”

Clients can then verify subordinate services through multiple paths:
DNS-based path: A client retrieves the registration receipt from the subordinate's DNS zone, verifies the anchor's signature using an anchor public key obtained from the anchor's DNSSEC keys, and extracts the subordinate's public key from the receipt;
API-based path: The client queries the anchor's API for the subordinate service's current credential or credential fingerprint.
Cross-verification: The client compares the DNS-hosted receipt against the anchor's current API response. If DNS and the anchor API disagree on the credential (outside expected rotation or propagation windows), the discrepancy indicates potential DNS compromise, stale DNS data, or rotation/propagation issues that warrant further checks.

This hybrid approach provides several benefits:
Offline Resilience: DNS-cached receipts enable verification during anchor outages if the client has previously authenticated the anchor's public key.
Anomaly Detection: Clients can identify DNS tampering or faults by comparing DNS-hosted receipts with anchor API responses, reducing reliance on manual audits.
Defense in Depth: Successful forgery requires the compromise of multiple independent systems: the subordinate's DNS, the anchor's API, and the anchor's DNS zone.
Self-bootstrapping discovery: Clients encountering a subordinate service for the first time can authenticate anchors without prior configuration. When a client retrieves the receipt of a subordinate service (e.g., _receipt.SRV1.d1.com) and extracts the anchor's identifier (e.g., anchor.org) and signature, the client can perform a DNSSEC-validated lookup of the anchor's domain to obtain its public key, which it uses to verify the signature on the original receipt. This allows a complete trust chain to be established dynamically, using the subordinate's receipt to discover and then verify the anchor.

Challenges in hybrid anchoring include DNS record size limits (addressed by publishing fingerprints or short-form receipts), DNS propagation delays during key rotation (addressed by version numbers and grace periods), and the operational overhead of maintaining receipts in DNS (addressed by automation and API-driven DNS updates). The hybrid model is particularly valuable in high-security environments where defense in depth justifies additional operational complexity, and in scenarios where offline or degraded-connectivity verification is important.

In all three embodiments A, B and C, the architecture provides transport-independent authenticity: subordinate services sign their outputs and clients verify the signatures using anchor-distributed credentials, so responses are cryptographically authenticated regardless of the underlying transport protocol. This reduces, or in some deployments obviates, the need for additional transport-layer integrity protections (such as DNS-over-TLS (DoT) or DNS-over-HTTPS (DoH)) for the verification of signed outputs, since the responses are self-authenticating.

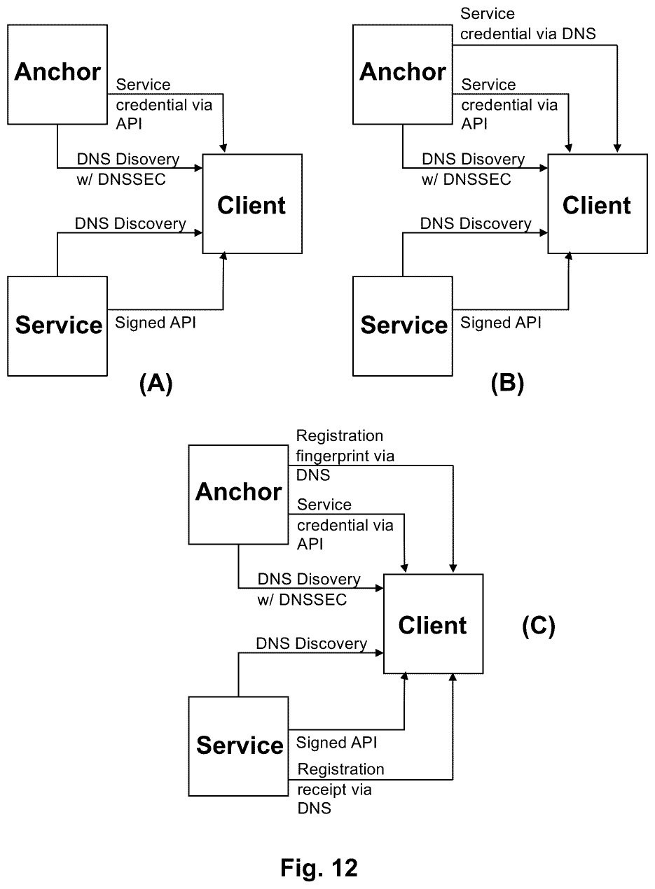

FIG. 12 depicts the three DTP schemes pictorially. (A) shows that clients discover the anchor and the subordinate service via DNS, get signed API payloads and verify the signatures using anchor-supplied credential. (B) shows that clients can obtain a subordinate's credential from the anchor's DNS zone as well, catering to offline verification. (C) shows bidirectional verification of the service credential from the subordinate's DNS (registration receipt), confirmed by a corresponding fingerprint at the anchor's DNS.

### 3.3 Privacy and Access Control

The DTP anchor service can enforce access control for signing credentials. While some embodiments offer full public access, others restrict disclosure based on policy, regulation, or privacy preferences. For example, an enterprise anchor may openly share public-facing credentials while shielding internal keys behind authentication. In the DKA framework, users can utilize privacy flags to limit disclosure to approved requesters. This model enables privacy-preserving distribution impossible in the public disclosure model of DNS-based certificates (e.g., DANE/TLSA). It also provides anti-reconnaissance defenses (such as rate limiting, authenticated bulk access, and query logging) that are unavailable in public DNS. These protections are vital for preventing user enumeration, protecting organizational structures, ensuring regulatory compliance (GDPR, HIPAA), and securing critical infrastructure.

In some embodiments, anchor-side access control is combined with privacy-preserving credential formats (such as pseudonymous identifiers, minimal disclosure of attributes, or attribute-based signatures), enabling frameworks that provide verifiable cryptographic assurances while limiting unnecessary disclosure of user or service metadata.

### 3.4 Applications Beyond DKA

The DTP architecture extends beyond the DKA framework. Its separation of discovery and verification, along with optional DNSSEC trust propagation, applies to a broad range of multi-domain service frameworks. Below we show two detailed example and mention others.

### 3.4.1 Certificate Transparency (CT)

CT is a critical security mechanism for TLS certificates and all major browsers require Certificate Authorities (CAs) to publicly log issued certificates in append-only, cryptographically verifiable logs. Browsers and other relying parties verify that a presented TLS certificate is accompanied by one or more Signed Certificate Timestamps (SCTs), cryptographic receipts attesting that the certificate has been included in a CT log. A SCT is signed using the log's private key, and relying parties validate an SCT with the log's public key.

In current CT deployments, log public keys are trusted through browser or OS policy configuration or via HTTP retrieval from the log operator's domain. For example, a browser may include a curated list of trusted logs and their public keys and operators may publish log keys under their domains (e.g., ct.example.com). Curated lists require manual updates and HTTP-based key distribution inherits log operator's DNS vulnerabilities: if DNS for ct.example.com is compromised, an attacker may redirect clients and serve a forged log key. Existing specifications (RFC 6962, RFC 9162) note threats to log signing keys but do not define a specific solution.

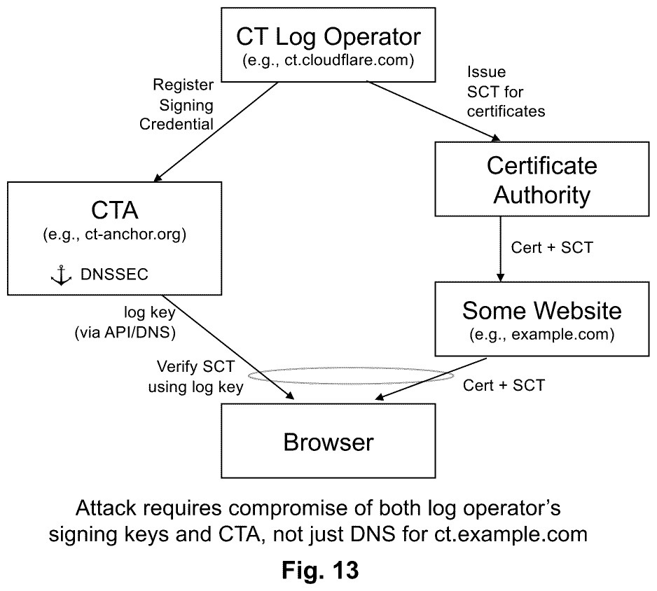

DTP addresses this gap through a CT Trust Anchor (CTA) —a cryptographic anchor service that provides DNS-independent verification of CT log signing credentials. As shown in FIG. 13, the CTA operates at a well-known, DNSSEC-secured domain (e.g., ct-anchor.org) and maintains a registry of verified signing credentials for CT logs operated across diverse domains (e.g., ct.cloudflare.com, ct.google.com, ct.digicert.com). Log operators register their signing authorities (e.g., admin@ct.cloudflare.com) and corresponding public keys with the CTA using an email-based verification scheme largely similar to the EVCA process. In some embodiments, the CTA verifies control of the signing-authority email address via DKIM authentication, challenge-response using the email account, and/or proof of private-key possession.

Upon successful verification, the CTA stores an association between a log identifier (for example, a log URL or cryptographic identifier) and the verified signing public key, and makes this credential available to relying parties (e.g., browsers, auditors) via API and/or DNS.
API: A client performs a DNSSEC-validated lookup of ct-anchor.org and issues a query such as/api/v1/logs?log_id=cloudflare-ct-2025. The CTA responds with the log's signing public key and in some embodiments a CTA-signed registration receipt.
DNS-based retrieval: The CTA publishes the log's credential as a DNSSEC-signed TXT record in its own zone (e.g., _log.cloudflare.ct-anchor.org IN TXT “v=DTP1 log_id=cf-ct-2025 alg=ecdsa-p256 key=MFk . . . 0DQgAE . . . ”). Clients DNSSEC-validate this record to extract the authoritative log key, enabling offline or cache-assisted verification.

When a browser receives an SCT alongside a TLS certificate, it extracts the log identifier from the SCT, obtains the log's signing public key from the CTA (via API or DNS), and verifies the SCT's signature, validating the SCT without DNSSEC deployment at each log operator's domain. In many deployments, an attacker seeking to forge SCTs that validate against CTA-distributed keys must compromise both the log operator's environment (for example, the log's signing private key or the signing-authority mailbox used during registration) and either the CTA itself or the DNSSEC-protected trust chain to the CTA, rather than a single DNS compromise.

The CTA is a O(1) DNSSEC deployment: only the anchor domain (ct-anchor.org) requires DNSSEC configuration, yet all participating CT logs benefit from DNSSEC-rooted trust in their signing keys. This substantially reduces operational burden compared to per-log DNSSEC deployment or DANE-style TLSA records, which require DNSSEC and TLSA publishing at each log domain. Because credential distribution is decoupled from log operation, logs may rotate keys, revoke credentials, or update metadata via the CTA without modifying their own DNS zones, enabling rapid incident response and flexible key lifecycle management.

The architecture also supports multi-anchor resilience: multiple CTAs (operated, for example, by the CA/Browser Forum, ICANN, or regional consortia) may independently verify and publish log credentials. Clients may, in some embodiments, require agreement among multiple anchors before accepting a log key, further hardening the CT ecosystem.

FIG. 13 shows a DTP-anchored CT verification flow: (1) a log operator registers its signing credentials with the CTA; (2) a client receives a TLS certificate and an SCT; (3) the client queries the CTA for the log's signing key; and (4) the client verifies the SCT using the CTA-provided key. This completes an end-to-end cryptographic chain from the DNS root→CTA (via DNSSEC)→log signing key (via CTA)→SCT (via log signature)→TLS certificate.

### 3.4.2 IoT Device Attestation

In zero-trust IT environments such as enterprise networks and cloud deployments, plugged-in IoT devices benefit from being able to self-register and self-attest to their state—including identity, firmware, configuration, and boot status—so that enterprise or cloud registries can register the device and users or applications can trust its identity.

In an IoT device attestation framework, an industry consortium operates an anchor service at a DNSSEC-protected domain (e.g., iot-anchor.org) to enable device authentication across multiple IoT manufacturers without requiring each manufacturer to deploy DNSSEC. Manufacturers operating at various domains (sensor-maker.com, appliance-corp.net, industrial-iot.com) register their attestation authority (AA) public keys with the anchor through email verification or certificate-based authentication. The anchor publishes these AA public keys in its own DNSSEC-protected DNS zone as TXT records (e.g., _aa.sensor-maker.iot-anchor.org TXT “v=DTP1 alg=ecdsa-p256 key= . . . ”), signed with the anchor's zone-signing key.

Each manufacturer embeds attestation certificates in its devices, where each certificate is signed by the manufacturer's AA private key and binds a device identifier to the device's public key. When a device attests to a verifier (cloud service, gateway, enterprise system), the verifier extracts the manufacturer identifier from the device's certificate, performs a DNSSEC-validating query for _aa.<manufacturer>.iot-anchor.org, obtains the manufacturer's AA public key from the validated DNS record, and verifies the device certificate's signature using that AA public key. The verifier then uses the device public key from the certificate to verify the device's attestation report (firmware version, boot state). Optionally, a verifier can also obtain a manufacturer's AA public key from the AA via API for cross validation with the key obtained from the DNS record.

This architecture enables O(1) DNSSEC deployment: only the consortium's anchor is DNSSEC-protected, yet all manufacturers benefit from DNSSEC-backed authentication. Compromising a manufacturer's DNS cannot forge attestations because AA public keys are anchored in the consortium's DNSSEC zone, not the manufacturer's. DNS-based distribution supports offline verification, allowing authentication even during anchor outages, all while exempting manufacturer domains from DNSSEC deployment or operational overhead.

### 3.4.3 Other Applications

Federated Identity: In federated identity systems (e.g., SAML or OpenID Connect), identity providers (IdPs) can register assertion-signing keys with an anchor. Relying parties verify identity assertions using keys obtained from the anchor, decoupling assertion verification from the IdP's own DNS configuration and enabling strong cryptographic assurances even when individual IdP domains do not deploy DNSSEC. The anchor can also enforce policy (e.g., which IdPs are authorized for a given relying party or tenant).

Blockchain Oracles: Oracle nodes that provide off-chain data to smart contracts can register signing keys with an anchor. On-chain logic or off-chain verifiers use anchor-provided keys to verify oracle-signed data. This ties the authenticity of oracle data to a DNSSEC-protected anchor and strengthens oracle security without each oracle domain managing its own DNSSEC.

Private and Internal Networks: Even where DNSSEC is not deployed, DTP's Part I anchoring is useful for enterprise CDNs, microservices, and API gateways. An organization can operate an internal or external anchor whose trust is established by policy, distribute service credentials through the anchor, and use signed responses to mitigate DNS-based redirection attacks inside private networks, gaining many of the benefits of DNSSEC without its complexity.

### 3.5 Summary

These examples illustrate that DTP is a general architectural pattern: an anchor service, one or more registration mechanisms separated from DNS designation, signed outputs from subordinate services, and client verification against anchor-provided credentials. Whether the anchor is DNSSEC-protected, hard-coded, or policy-provisioned, the same separation of discovery and cryptographic verification applies across diverse application domains.

1. A system for serving cryptographically verifiable signing credentials of Domain Key Authorities (DKAs), the system comprising one or more servers that implement a Domain Key Authority Trust Anchor (DTA), the one or more servers comprising at least one processor and a non-transitory computer-readable medium storing instructions that, when executed by the at least one processor, cause the DTA to:
receive, from a DKA, a registration request comprising:
a signing-authority identifier that identifies a signing authority for the DKA; and
a signing public key asserted to be associated with the signing authority;
verify that the DKA controls an email address identified by the signing-authority identifier, using an email-based verification scheme;
in response to successful verification, store, in a registry of signing credentials maintained by the DTA, an association between the DKA and a signing credential comprising the signing-authority identifier and the signing public key;
receive, from a client, a request for verification material corresponding to a specified DKA;
generate verification material comprising at least the signing public key associated with the specified DKA; and
transmit, to the client, the verification material for use by the client in verifying digital signatures that the DKA applies to responses to requests for public keys of email addresses,
wherein the DTA operates at a first Internet domain, and the DKA is designated, via a Domain Name System (DNS) record, by a second Internet domain that is different from the first Internet domain, as an authoritative distributor of public keys associated with email addresses.

2. The system of claim 1, wherein verifying that the DKA controls the email address identified by the signing-authority identifier comprises the DTA sending, to the email address, a verification message containing a unique verification token, and the DTA verifying control of the email address based on receipt, from the email address, of a confirmation message that includes information derived at least in part from the unique verification token.

3. The system of claim 1, wherein verifying that the DKA controls the email address identified by the signing-authority identifier comprises the DTA authenticating an email message received from the email address using a DomainKeys Identified Mail (DKIM) signature.

4. The system of claim 1, wherein verifying that the DKA controls the email address identified by the signing-authority identifier comprises the DTA sending, to the email address, a cryptographic challenge, and receiving, from the email address, a response derived based, at least in part, on the private key corresponding to the signing public key.

5. The system of claim 1, wherein the DKA is designated by the second Internet domain as an authoritative distributor of public keys associated with email addresses belonging to the second Internet domain.

6. The system of claim 1, wherein the DKA is a root DKA (rDKA) operating as a wildcard authority for email addresses belonging to any Internet domain.

7. The system of claim 1, wherein the DTA is discoverable at a predetermined network address.

8. The system of claim 1, wherein the DTA is discoverable at a predetermined domain, and DNS records for the predetermined domain are secured via DNS Security Extensions (DNSSEC).

9. The system of claim 1, wherein the DTA is further configured to generate, upon successful verification, a signed registration receipt comprising the signing-authority identifier, the signing public key, and a digital signature of the DTA created using the DTA's private key.

10. The system of claim 1, wherein the DTA is one of a plurality of DTAs operating at respective Internet domains, and wherein each DTA of the plurality of DTAs independently receives and verifies signing credentials from DKAs.

11. A computer-implemented method performed by a Domain Key Authority Trust Anchor (DTA) for serving cryptographically verifiable signing credentials of Domain Key Authorities (DKAs), the method comprising:
receiving, from a DKA, a registration request comprising:
a signing-authority identifier that identifies a signing authority for the DKA; and
a signing public key asserted to be associated with the signing authority;
verifying that the DKA controls an email address identified by the signing-authority identifier, using an email-based verification scheme;
in response to successful verification, storing, in a registry of signing credentials maintained by the DTA, an association between the DKA and a signing credential comprising the signing-authority identifier and the signing public key;
receiving, from a client, a request for verification material corresponding to a specified DKA;
generating verification material comprising at least the signing public key associated with the specified DKA; and
transmitting, to the client, the verification material for use by the client in verifying digital signatures that the DKA applies to responses to requests for public keys associated with email addresses,
wherein the DTA operates at a first Internet domain, and the DKA is designated, via a Domain Name System (DNS) record, by a second Internet domain that is different from the first Internet domain, as an authoritative distributor of public keys associated with email addresses.

12. The computer-implemented method of claim 11, wherein verifying that the DKA controls the email address identified by the signing-authority identifier comprises the DTA sending, to the email address, a verification message containing a unique verification token, and the DTA verifying control of the email address based on receipt, from the email address, of a confirmation message that includes information derived at least in part from the unique verification token.

13. The computer-implemented method of claim 11, wherein verifying that the DKA controls the email address identified by the signing-authority identifier comprises the DTA authenticating an email message received from the email address using a DomainKeys Identified Mail (DKIM) signature.

14. The computer-implemented method of claim 11, wherein verifying that the DKA controls the email address identified by the signing-authority identifier comprises the DTA sending, to the email address, a cryptographic challenge, and receiving, from the email address, a response derived based, at least in part, on the private key corresponding to the signing public key.

15. The computer-implemented method of claim 11, wherein the DKA is designated by the second Internet domain as an authoritative distributor of public keys associated with email addresses belonging to the second Internet domain.

16. The computer-implemented method of claim 11, wherein the DKA is a root DKA (rDKA) operating as a wildcard authority for email addresses belonging to any Internet domain.

17. The computer-implemented method of claim 11, wherein the DTA is discoverable at a predetermined network address.

18. The computer-implemented method of claim 11, wherein the DTA is discoverable at a predetermined domain, and DNS records for the predetermined domain are secured via DNS Security Extensions (DNSSEC).

19. The computer-implemented method of claim 11, wherein the method performed by the DTA further comprises: generating, upon successful verification, a signed registration receipt comprising the signing-authority identifier, the signing public key, and a digital signature of the DTA created using the DTA's private key.

20. A system for enabling cryptographic verification of outputs from Internet services designated via Domain Name System (DNS) records, the system comprising one or more servers that implement a cryptographic trust anchor, the one or more servers comprising at least one processor and a non-transitory computer-readable medium storing instructions that, when executed by the at least one processor, cause the cryptographic trust anchor to:
receive, from a subordinate service, a registration request comprising:
a signing-authority identifier that identifies a signing authority for the subordinate service; and
a signing public key asserted to be associated with the signing authority;
verify that the subordinate service controls an email address identified by the signing-authority identifier, using an email-based verification scheme;
in response to successful verification, store, in a registry of signing credentials maintained by the cryptographic trust anchor, an association between the subordinate service and a signing credential comprising the signing-authority identifier and the signing public key;
receive, from a client, a request for verification material corresponding to a specified subordinate service;
generate verification material comprising at least the signing public key associated with the specified subordinate service; and
transmit, to the client, the verification material for use by the client in verifying digital signatures that the subordinate service applies to its outputs, the outputs including signed responses to client queries,
wherein the cryptographic trust anchor operates at a first Internet domain, and the subordinate service is designated, via a DNS record, by a second Internet domain that is different from the first Internet domain.
